(19) United States
(12) Patent Application Publication
(10) Pub. No.: US 2005/0046739 A1
(43) Pub. Date: Mar. 3, 2005

(54) System and method using light emitting diodes with an image capture device

(76) Inventors: James S. Voss, Fort Collins, CO (US); Rob Haas, Fort Collins, CO (US); Kirk S. Tecu, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/652,123

(22) Filed: Aug. 29, 2003

(51) Int. Cl. H04N 5/222

(52) U.S. Cl. 348/371

(57) ABSTRACT

In accordance with at least one embodiment of the present invention, a method is provided that comprises arranging a plurality of light emitting diodes (LEDs) to form a strobe for an image capture device. The method further comprises controlling an intensity of light emitted by the LEDs during an image capture process such that intensity of light emitted by one region of the LEDs is different than intensity of light emitted by another region of the LEDs.

### FIELD OF THE INVENTION

The present invention relates in general to image capture devices and processes, and more particularly to systems and methods for using light emitting diodes (LEDs) with an image capture device.

### DESCRIPTION OF RELATED ART

Devices for capturing still and/or moving images are a common part of today's society. Film cameras (e.g., 35 mm cameras), digital cameras, and camcorders are examples of image capture devices that are widely used by individuals. Digital cameras are finding increasingly wide usage, and are even being incorporated into such devices as cellular telephones and personal digital assistants (PDAs). In general, the size of such image capture devices (e.g., digital cameras, etc.) are decreasing (for improved portability), while the complexity and available features of such image capture devices are increasing. For instance, the image resolution, zoom capability, image storage capacity, and various other features of digital cameras are continually improving.

Various factors influence the quality of images captured by a camera. One factor that influences the quality of captured images is lighting. To capture a good image of a scene, proper lighting of the scene is desirable. Often, the ambient lighting of a scene is not sufficient for capturing a quality image thereof. Thus, cameras typically include a strobe (or “flash”) for supplementing the ambient light. Traditionally, cameras have used a xenon discharge lamp (or strobe) to illuminate an object. Xenon strobes produce a very brilliant flash that will project light a long distance, thus enabling the flash to supplement the ambient lighting of objects that are relatively far away from the camera.

“Hot shoes” are often included on high-end single lens reflex (SLR) cameras. A hot shoe is a clip on the body of a camera for clipping a large strobe to the camera. The hot shoe enables a signal to be routed from the camera to the added strobe, which allows any of various sorts of different strobes to be attached to the camera (e.g., for achieving different lighting effects).

As mentioned above, xenon strobes are traditionally used to supplement ambient lighting. Xenon strobes are relatively large, and thus consume an undesirably large amount of space within a camera. For example, traditional xenon strobe implementations are typically approximately 1 to 1.5 inches long and are approximately half an inch in diameter, which consumes an undesirably large amount of space within the camera. Thus, while cameras are getting increasingly smaller, traditional strobe implementations limit the amount by which the size of a camera can be reduced. Additionally, the space consumed by traditional strobes within a camera is not available for implementing other functionality (e.g., more logic, increased storage, etc.). Further, xenon strobes typically consume an undesirably large amount of energy to flash. For example, a capacitor is typically charged up to between 180 and 300 volts, and then discharged for triggering the strobe illumination. Thus, traditional xenon strobes are inefficient in terms of the energy required for their usage.

Cameras use a variety of techniques for achieving the proper exposure of photographs. Commonly, a camera makes one or more trial photographs of a scene using selected camera settings. These trial photographs are analyzed to determine the amount of light being captured from the scene and how the exposure should be adjusted to improve the exposure level. The camera may then adjust any of several settings before taking a final photograph so that proper exposure is achieved.

Some of the camera settings which may be adjusted include the shutter time (either mechanical or electronic), the lens aperture ratio, the electronic amplification of signals within the camera (sometimes called system gain), whether a strobe light should be fired to supplement the ambient lighting of the scene, and if so, how much energy to supply to the strobe. The more energy supplied to the strobe, the more light the strobe emits, and the brighter the exposure of the resulting photograph. In some cases the user of the camera may specify some or all of the settings and require the camera to adjust any remaining settings to achieve proper exposure.

A common technique for determining the proper strobe energy, for example, is to take a trial photograph with the strobe energy set to a known amount. The resulting photograph is examined and its exposure quality evaluated. If adjustment is required, a new value for the strobe energy is determined. The final photograph is then taken using the computed energy value. However, this process may be distracting and/or inconvenient to the subjects being photographed. A more common technique is for the camera to know the light value of the scene's ambient light (e.g., through user settings and/or through logic for detecting the light value, commonly referred to as illuminant detect logic) and then determine, based on a known photographic formula that calculates how much additional light is needed for a good image of the scene and based on known characteristics of the strobe, how long to illuminate the strobe to achieve the desired illumination of the scene.

In order to determine which adjustments should be made to its settings, the camera may assume a definition of proper exposure and incorporate knowledge of how each potential adjustment will affect the exposure in the final photograph. As used herein, a “photograph” or “captured image” may be a numerical representation of a scene captured by a camera or other image capture device, and need not be a printed representation or user-viewable image of the scene.

In addition to the amount or intensity of ambient lighting of a scene, another factor associated with lighting that influences a captured color image of the scene is the composition of the spectrum of the ambient lighting. For instance, the amount of color detected by each detector of a camera may be altered due to the composition of the spectrum of light emitted by the particular light source illuminating the scene. For example, if a scene is illuminated by a tungsten light source, then an image of the scene will be shifted toward the red spectrum because tungsten light sources emit more red light than blue or green light. This shift will give the resulting photograph an undesirable reddish/orangish appearance.

One method that has been used in cameras to process an image to adjust for differences in the nature of the ambient light illuminating a scene utilizes variable gain amplifiers that are arranged in line with the red and blue signals. The amount of gain applied to the red and blue signals is adjusted to compensate for the type of light which illuminates the scene. A manual control on the camera allows the user to select between tungsten mode and daylight mode, for example. In tungsten mode, the gains of the amplifiers that are responsible for amplifying the output from the red and blue detectors are set to a first gain ratio to compensate for the red shift. In daylight mode, a second gain ratio is used which causes the gain of the amplifiers responsible for amplifying the red and blue signals to be approximately equal to the amount of gain which is set for the green signals. Thus, by altering the gain of the amplifiers responsible for amplifying the outputs from the red and blue detectors, the color is properly balanced for the case in which an image is to be captured in tungsten lighting or in daylight, as examples.

Additionally, factors internal to the camera (e.g., factors concerning the capturing and/or processing of an image by a camera) may influence the quality of images. For instance, a lens used in the camera may contribute certain undesired artifacts to captured images. For instance, a lens typically does not treat received light uniformly along its length. Thus, in certain areas of the lens, it may absorb or reflect more light than in other areas of the lens. For example, often light is treated differently around the edges of a lens such that the light focused on the detector array is not uniform across the entire image. A lens often treats different wavelengths of light differently along its length, and often treats light of certain wavelengths received at its edge much differently than it treats light of those certain wavelengths at other areas (e.g., at the center) of the lens. Cameras typically undergo a tremendous amount of calibration during manufacturing in an attempt to adjust its operation to correct/alleviate such internal factors that negatively impact the quality of a captured image. For instance, such calibration often involves adjusting the gain of amplifiers responsible for amplifying the outputs from certain ones of the detectors to correct for lens artifacts and/or other internal factors that negatively impact the quality of a captured image.

### BRIEF SUMMARY OF THE INVENTION

In accordance with at least one embodiment of the present invention, a method is provided that comprises arranging a plurality of light emitting diodes (LEDs) to form a strobe for an image capture device. The method further comprises controlling an intensity of light emitted by the LEDs during an image capture process such that intensity of light emitted by one region of the LEDs is different than intensity of light emitted by another region of the LEDs.

According to at least one embodiment, a method comprises arranging a plurality of LEDs of different colors to form a strobe for an image capture device. The method further comprises controlling an intensity of light emitted by the LEDs such that an intensity of light emitted by at least one LED of a first color is different than an intensity of light emitted by at least one LED of a second color that is different from the first color.

According to at least one embodiment, a method comprises arranging a plurality of LEDs to form a strobe for an image capture device. The method further comprises using the plurality of LEDs for supplementing ambient light of a scene during an image capture process that uses the image capture device to capture an image of such scene, and using the plurality of LEDs during the image capture process to correct for at least one defect of the image capture process.

According to at least one embodiment, an image capture device is provided that comprises a plurality of LEDs forming a strobe. The image capture device further comprises control logic for controlling an intensity of light emitted by the LEDs during an image capture process such that intensity of light emitted by one region of the LEDs is different than intensity of light emitted by another region of the LEDs.

According to at least one embodiment, a system is provided that comprises means for capturing an image of a scene. The capturing means comprises means for generating illumination for the scene during an image capture process, wherein the generating means comprises a plurality of LEDs for supplementing ambient light of the scene in a manner that corrects for at least one defect of said image capture process.

According to at least one embodiment, an image capture device comprises a plurality of means for generating light for illuminating a scene being imaged by the image capture device during an image capture process. The image capture device further comprises means for controlling an intensity of light emitted by the plurality of light generating means during the image capture process such that intensity of light emitted by at least one of the plurality of light generating means is different than intensity of light emitted by at least one other of the plurality of light generating means.

According to at least one embodiment, an image capture device comprises a plurality of means for generating light for illuminating a scene being imaged by the image capture device during an image capture process, wherein the plurality of light generating means comprise at least one means for generating light of a first color and at least one means for generating light of a second color that is different from the first color. The image capture device further comprises means for controlling an intensity of light emitted by the plurality of light generating means during the image capture process such that an intensity of light emitted by the at least one means for generating light of the first color is different than an intensity of light emitted by the at least one means for generating light of the second color.

### BRIEF DESCRIPTION OF THE DRAWINGS

FIG. 1 shows an example block diagram of a digital camera implemented in accordance with an embodiment of the present invention;

FIG. 2 shows an example of one implementation of LEDs within an image capture device for correcting for an internal defect of an image capture process;

FIG. 3 shows an example of another implementation of LEDs within an image capture device for correcting for an internal defect of an image capture process;

FIG. 4 shows an example camera that includes strobe profile information, which includes internal defect correction information that may be used for determining a proper lighting strategy to implement with LEDs for correcting an internal defect of an image capture process according to one embodiment;

FIG. 5 shows an example of one implementation of LEDs within an image capture device for correcting for an external defect of an image capture process;

FIG. 6 shows an example camera that includes strobe profile information, which includes external defect correction information that may be used for determining a proper lighting strategy to implement with LEDs for correcting an external defect of an image capture process according to one embodiment;

FIG. 7 shows an example camera that includes strobe profile information that includes both internal defect correction information and external defect correction information, which may be used for determining a proper lighting strategy to implement with LEDs for correcting the internal and external defects of an image capture process according to one embodiment; and

FIG. 8 shows an example operational flow diagram of an embodiment of the present invention.

### DETAILED DESCRIPTION

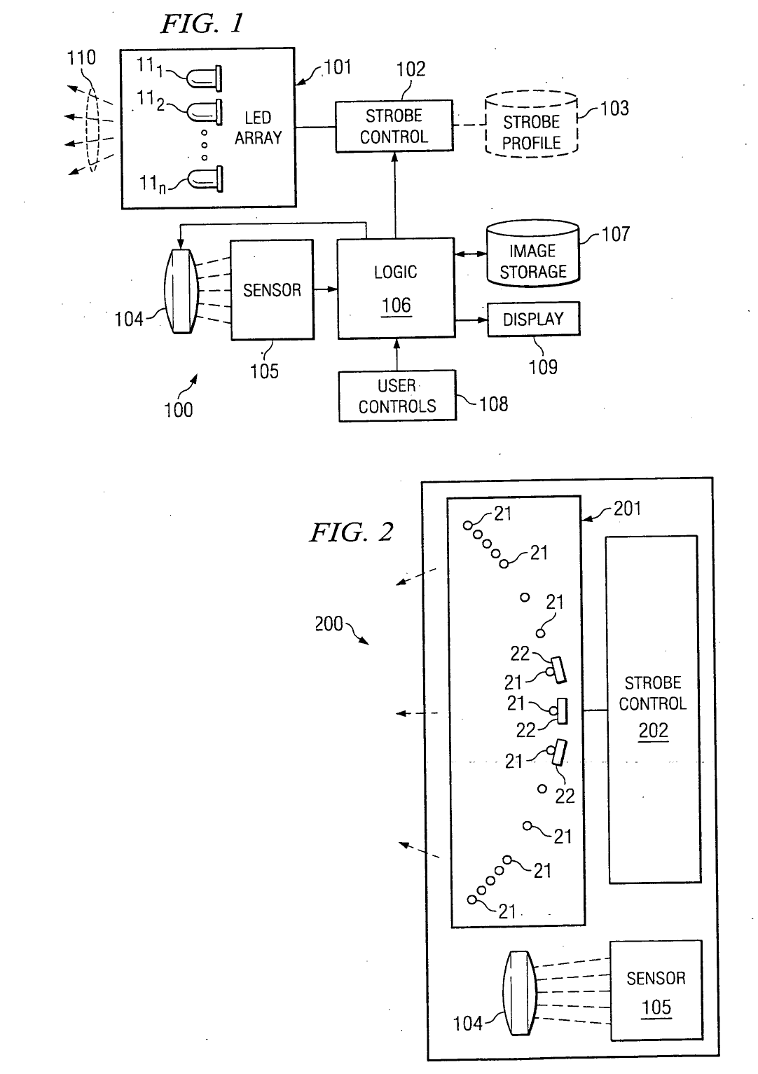

FIG. 1 shows an example block diagram of a digital camera 100 implemented in accordance with an embodiment of the present invention. It will be appreciated that while example implementations are described herein for a digital camera, embodiments of the present invention are not limited in application to digital cameras but may be equally applied for other image capture devices, including without limitation film cameras and video recorders. Further, the image capture devices with which embodiments of the present invention may be implemented need not be devices dedicated solely to performing image capture, but may be devices that perform other functions, such as cellular telephones or PDAs, that also include image capture functionality.

The example digital camera 100 of FIG. 1 includes a lens 104 that gathers light from a scene (not shown). In operation, the gathered light is redirected (or focused) by lens 104 to form an image of a scene being imaged on sensor 105. As is well-known in the art, sensor 105 may be an array of CCD elements, complementary metal-oxide semiconductor (CMOS) sensors, or the like. For capturing color images, color filters (not shown) may be arranged between lens 104 and sensor 105, as described above.

A digital camera, or an exposure sensor for a film camera, by its nature, produces a numerical representation of each photograph it takes. For each location in the photograph, called a “picture element” or “pixel,” the camera typically records a numerical value indicating the brightness of the scene at that location. The resulting representation of the scene is then an array of numbers. Locations in the array correspond to specific pixels, or locations in the scene, and the number stored at each array location represents the scene brightness at that location. Optionally, the camera may also record information about the color at each pixel location of the scene being photographed. For example, many cameras represent the color of a pixel using three components indicating the contribution of red, green, and blue wavelengths of light to the brightness of that pixel. The overall brightness of a pixel may be computed as the sum of the red, green, and blue contributions, as a weighted sum, or as some other combination of the color information. A variety of methods for computing the brightness of a pixel from color information are well-known in the art.

Camera 100 may comprise a display 109 on which image data may be shown. Additionally, camera 100 may comprise a storage unit (e.g., flash memory) 107 for storage and recall of image data, as well as data interchange with other devices (not shown). Further, various user controls (inputs) 108 may be included to enable a user to affect the operation of the camera (e.g., to zoom, focus, trigger the capture of an image, etc.).

Generally, the operation of lens 104 may be controlled by control signals from a logic unit 106 which typically contains a microprocessor system. Likewise, the operation of sensor 105 may be controlled by control signals from logic unit 106. Image information signals flow from sensor 105 to logic unit 106, and such image information may be processed, displayed via display 109, and/or stored to data storage 107 (e.g., flash memory).

In accordance with an embodiment of the present invention, camera 100 includes strobe 01 that is formed by a plurality of light emitting diodes (LEDs). For instance, an array of LEDs 11₁, 11₂, . . . , 11ₙ (wherein n is any desired number) may be included to form strobe 101. As with traditional strobes, strobe (or “flash”) 101 may be utilized to supply additional light 110 to the scene being imaged (not shown). That is, strobe 101 may be used to supplement the ambient light of a scene being imaged. It should be understood that in this sense the ambient light of a scene may include natural lighting (e.g., light from the Sun, moon, stars, etc.) and/or man-made lighting (e.g., fluorescent lighting, tungsten lighting, halogen lighting, etc.).

In general, LEDs are smaller and typically require less energy than traditional xenon strobes. Further, LEDs are available that are capable of outputting relatively high intensity (or bright) light. For instance, LEDs having sufficient intensity to overcome sunlight are beginning to be used within traffic lights. Further, a plurality of LEDs implemented according to an embodiment of the present invention may enable an output lighting strategy to be implemented wherein different LEDs output light of different intensities, as described further below, whereas traditional xenon strobes are not capable of implementing such a lighting strategy.

As described further herein, the LEDs forming strobe 101 may be used not only to supplement ambient lighting of a scene, but also to correct for defects (or undesired features) in the image capture process. For instance, the LEDs may be used to correct for internal defects, such as the non-uniform treatment of light across lens 104 (e.g., to eliminate undesirable artifacts that would otherwise be contributed to an image by lens 104). As another example, the LEDs may be used to correct for external defects in the image capture process, such as an undesired contribution of color to a scene by its ambient lighting. Thus, in certain embodiments post-processing of captured image data with gain amplifiers, etc. may be unnecessary or at least reduced because of defect correction being handled during the image capture process through a lighting strategy applied by the LEDs of strobe 101.

It should be understood that internal and external “defects” (or “undesired features”) are used herein to refer to factors that may negatively impact the quality of a captured image. For instance, internal defects are factors internal to the camera that negatively impact the quality of a captured image, such as the camera's lens (and/or other components and/or image processing operations) contributing undesired artifacts to an image (if not corrected). External defects are factors that are external to (and/or not under the control of) the camera that negatively impact the quality of a captured image (if not corrected), such as an undesired contribution of color to a scene by its ambient light source (e.g., contribution of a reddish tint by a tungsten light source, etc.). While the camera may function properly by capturing such color contributions from a scene's ambient lighting (and thus capturing such color contributions of the ambient lighting is not literally a defect in the operation of the camera), such color contributions may be an undesired feature that negatively impacts the quality of the captured image, and thus may be referred to as an external “defect” or “undesired feature.”

In the example implementation of FIG. 1, strobe 101 is operated by strobe control logic 102, which may be communicatively coupled to logic unit 206. For instance, strobe control 102 may control the intensity of different ones of LEDs 11₁-11ₙ to enhance the quality of a captured image (e.g., to correct for internal and/or external defects of the image capture process), as described further below. For example, by controlling the amount of power supplied to each LED, the intensity of light output by each LED during an image capture process can be controlled by strobe control 102 to implement a desired lighting strategy. As another example, the arrangement of the LEDs may be controlled and/or selected to control the intensity of light output by different regions thereof. For instance, LEDs may be more densely populated in a first region of strobe 101 than in another region so that the first region outputs higher intensity light. Such arrangement of the LEDs may be fixed during the manufacture of camera 100 to, for example, correct for a determined internal defect (e.g., that may be determined through a calibration process). In certain embodiments, the arrangement of the LEDs may be variable during operation of camera 100. For instance, actuators (e.g., micro-actuators) may be implemented for moving the LEDs to enable their relative positioning to be altered by strobe control 102.

As described further herein, in certain implementations strobe control 102 may use information available in a strobe profile 103 that is stored to a data storage unit (e.g., random access memory, flash memory, etc.) of camera 100 to determine the appropriate lighting strategy to be used for imaging a scene, and strobe control 102 may control the LEDs of strobe 101 to implement such lighting strategy. For instance, strobe profile information 103 may include information regarding the type and amount of correction needed for an internal defect of camera 100, such as for correcting for non-uniform treatment of light across lens 104 (which may be determined through a calibration process). Additionally or alternatively, strobe profile information 103 may include information regarding the type and amount of correction needed for an external defect of the image capture process for a given scene, such as for correcting for undesired color contributions of various types of ambient light sources.

Strobe control 102 may also receive information from logic 106 to aid in determining an appropriate lighting strategy, including as examples information about user-controlled settings 108 (e.g., information about the type of ambient light conditions under which the scene is being imaged, such as outdoors versus indoors, etc.) and/or focus information (e.g., to determine a field of view of the scene that is being imaged). Thus, for instance, in certain implementations a user may specify a type of ambient light source under which a scene is being photographed (e.g., sunlight, fluorescent lighting, tungsten lighting, etc.), and logic 106 may convey this information to strobe control 102, which may determine (e.g., based on information available in strobe profile 103) the appropriate lighting strategy to be applied by strobe 101 during the image capture process. Further, in certain embodiments, logic (not shown) for determining the ambient lighting conditions of a scene being imaged may be included. For instance, logic (commonly referred to as illuminant detect logic) for analyzing the ambient lighting conditions of a scene and determining the type of ambient lighting may be included in camera 100. Illuminant detect logic is well-known in the art and is often implemented in cameras for detecting various different types of light sources. For instance, certain cameras include illuminant detect logic for detecting 15 different types of common ambient light sources, such as daylight, cloudy light conditions, dusk lighting, fluorescent lighting, etc.

Thus, in accordance with certain embodiments of the present invention, strobe control 102 may control the intensity of LEDs 11₁-11ₙ to not only supplement a scene's ambient lighting, but also to correct internal and/or external defects (or “undesired features”) in the image capture process. As mentioned above, one type of internal defect that is often encountered in an image capture device arises from its lens failing to treat light uniformly across its length. For instance, many lenses tend not to bend all wavelengths of light uniformly, and also tend to attenuate light more near their edges than near their centers. In accordance with certain embodiments of the present invention, a lighting strategy may be applied by LEDs 11₁-11ₙ to correct for such internal defect. An example of one implementation of LEDs within an image capture device for correcting for such an internal defect is shown in FIG. 2, described further below.

FIG. 2 shows an example block diagram illustrating a portion of a digital camera 200. As with camera 100 of FIG. 1, camera 200 includes a lens 104 and a sensor 105 for capturing image data. Various other components, such as those described in FIG. 1 above may also be included in camera 200, although not shown for simplicity. Camera 200 also includes a strobe 201 (which, for example, corresponds to strobe 101 of FIG. 1) that includes a plurality of LEDs 21. Such LEDs 21 are arranged, in this example, to implement a lighting strategy that corrects for an internal defect. For instance, LEDs 21 may be arranged to correct a defect of lens 104 in which lens 104 attenuates light more near its edges than near its center.

The arrangement of LEDs 21 is used to control the intensity of light output by different regions of strobe 201. For instance, in the example of FIG. 2, LEDs 21 are arranged in an arc and are more densely populated near each end of the arc than in the middle of the arc. Thus, greater intensity light is output at the end regions of the arc than the middle region of the arc. Accordingly, such lighting strategy may compensate (or correct) for lens 104 attenuating light more near its edges than near its center (e.g., by illuminating the edges of a scene more). Such arrangement of LEDs 21 may be fixed during the manufacture of camera 200 to correct for a determined internal defect (e.g., such as a defect associated with lens 104), which may be determined through a calibration process. In certain embodiments, the arrangement of LEDs 21 may be variable during operation of camera 200. For instance, actuators (e.g., micro-actuators) may be implemented for moving LEDs 21 to enable their relative positioning to be altered by strobe control 202. For instance, micro-actuators 22 are included for certain LEDs 21 in the example of FIG. 2, wherein strobe control 202 may selectively activate such micro-actuators to dynamically arrange LEDs 21 for implementing a desired lighting strategy (e.g., for increasing the density of population of LEDs in a given region of strobe 201). Thus, the LEDs may be controllably moveable in certain implementations (e.g., under the control of logic 106 (of FIG. 1) and/or strobe control 202). The LEDs may be controllably moved to dynamically vary the density of the population of LEDs in a particular region of strobe 101, thus effectively altering the intensity of light output by that region. Additionally or alternatively, the LEDs may be moved to dynamically vary the shape of their arrangement (e.g., to vary the shape of the arc of FIG. 2). The shape of such arc may be varied to, for example, change the focal length of the flash to correspond to that of the lens (e.g., responsive to zoom operations, etc.).

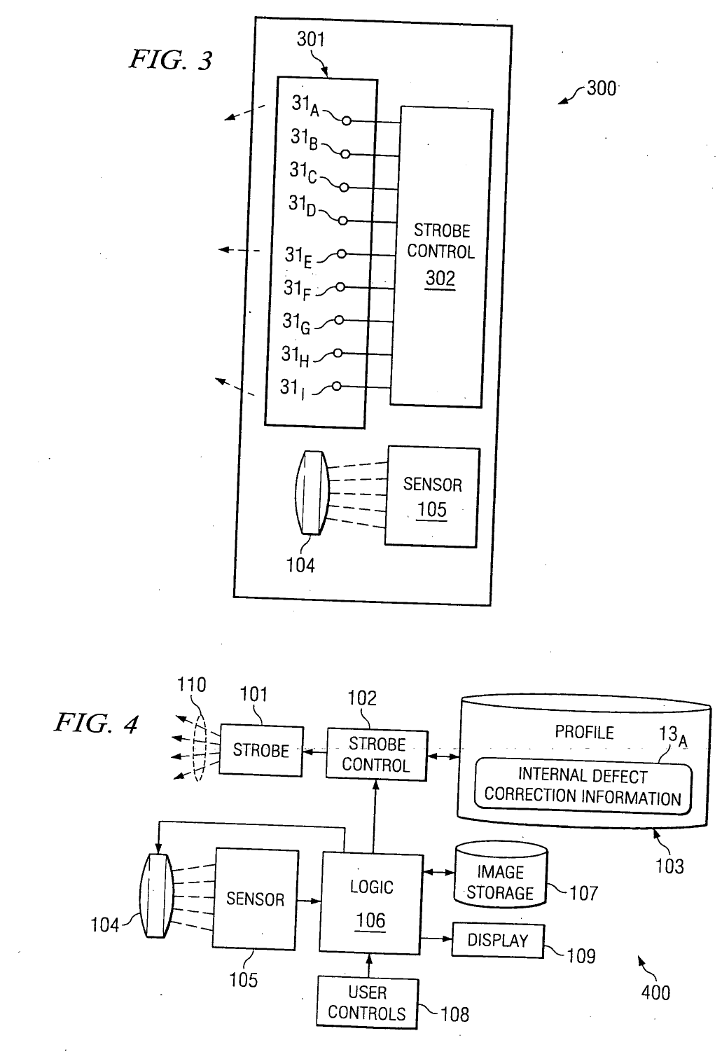

An example of another implementation of LEDs with an image capture device for correcting for an internal defect is shown in FIG. 3. FIG. 3 shows an example block diagram illustrating a portion of a digital camera 300. As with camera 100 of FIG. 1, camera 300 includes a lens 104 and a sensor 105 for capturing image data. Various other components, such as those described in FIG. 1 above may also be included in camera 300, although not shown for simplicity. Camera 300 also includes a strobe 301 (which, for example, corresponds to strobe 101 of FIG. 1) that includes a plurality of LEDs 31_{A}-31₁ (referred to collectively as LEDs 31). Such LEDs 31 are arranged in a uniformly spaced array in this example. However, strobe control 302 may selectively control the power supplied to each LED 31 (thereby controlling their respective intensities) during the flash of an image capture process to implement a lighting strategy that corrects for an internal defect. For instance, LEDs 31 may implement a lighting strategy similar to the above-described lighting strategy of FIG. 2, wherein the LEDs near each end of the array (e.g., LEDs 31_{A} and 31_{B}, and LEDs 31_{H} and 31₁) may be driven harder (e.g., supplied more power) than the LEDs arranged near the center of the array in order to correct a defect of lens 104 in which lens 104 attenuates light more near its edges than near its center. Thus, strobe control 302 may selectively drive different ones of LEDs 31 to different intensities for implementing a desired lighting strategy.

LEDs essentially emit light according to a supplied current. When a diode starts to conduct (emitting light for an LED) the voltage drop across the diode typically changes very little. Thus, the current may be varied to vary the intensity of a diode. Generally, varying current is more difficult than varying voltage. Therefore, in certain implementations a voltage-to-current converter (such as those known in the art) may be used, wherein the voltage input to the converter may be varied resulting in varying the current output by the converter and thus varying the intensity of a corresponding LED. Further, in certain implementations both the arrangement of LDSs (as in FIG. 2) and the power (or current) supplied to the LEDs (as in FIG. 3) may be controlled to control the intensity of light output by different regions of the LEDs.

As mentioned above with FIG. 1, in certain implementations strobe control 102 may use information available in a strobe profile 103 that is stored to a data storage unit (e.g., random access memory, flash memory, etc.) of camera 100 to determine the appropriate lighting strategy to be used for imaging a scene, and strobe control 102 may control the LEDs of strobe 101 (e.g., their arrangement and/or intensity) to implement such lighting strategy. FIG. 4 shows a block diagram of an example camera 400 which includes components as described above in FIG. 1. For instance, camera 400 includes strobe 101 which may, for example, implement a plurality of LEDs in the manner described above in FIG. 2 (e.g., strobe 201) or FIG. 3 (e.g., strobe 301). Further, camera 400 includes strobe profile information 103, which in this example includes internal defect correction information 13_{A} Internal defect correction information 13_{A} may include information regarding the type and amount of correction needed for an internal defect of camera 400, such as for correcting for non-uniform treatment of light across lens 104 (which may be determined through a calibration process). Such internal defect correction information 13_{A} may, for example, be input to camera 400 during a calibration process, and stored to data storage within camera 400 for later recall by strobe control 102. Thus, strobe control 102 may access internal defect correction information 13_{A} and use that information to determine a proper lighting strategy to implement with strobe 101 for correcting an internal defect of an image capture process.

Generally, a large amount of time and effort is spent designing lenses to be as accurate as possible (in an attempt to minimize the above-mentioned types of defects). Such design efforts significantly increase the cost of manufacturing and materials for an image capture device. With embodiments of the present invention, lower-quality lenses may be used in certain implementations to reduce the manufacturing and designs costs associated with an image capture device, and the lens defects may be corrected (calibrated out) at image capture time with a proper lighting strategy implemented by the image capture device's LEDs. Further, lenses are generally made larger than absolutely needed in order to minimize the above-described “near-edge” effects. Embodiments of the present invention may allow for smaller lenses to be used (by decreasing the amount of “slop” designed into the lens) with any “near-edge” defects being corrected at image capture time with a proper lighting strategy achieved by the image capture device's LEDs.

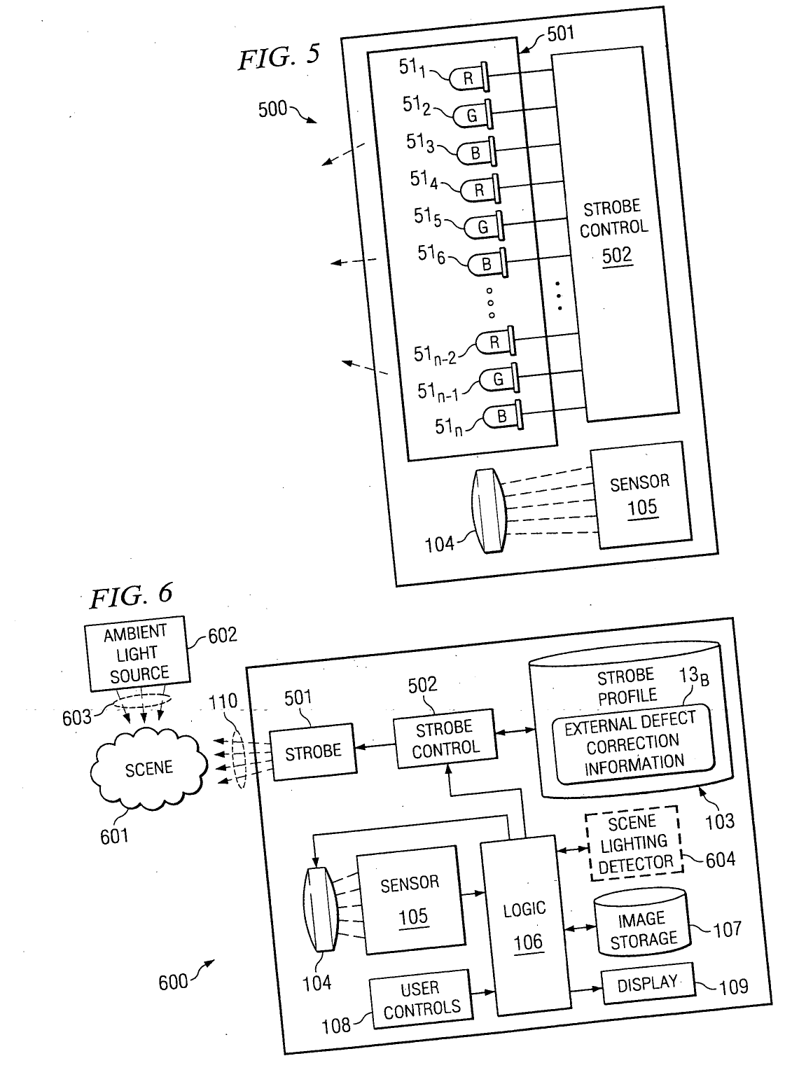

As mentioned above with FIG. 1, strobe control 102 may control the intensity of LEDs 11₁-11ₙ to not only supplement a scene's ambient lighting, but also to correct internal and/or external defects (or undesired features) in the image capture process. One type of external defect (i.e., defect that is external to or out of the control of camera 100) that is often encountered in an image capture process arises from the undesired contribution of color to a scene by its ambient lighting. For instance, different ambient light sources may contribute different color characteristics to a scene. For example, a tungsten light source may contribute a reddish color to a scene. In accordance with certain embodiments of the present invention, a lighting strategy may be applied by LEDs 11₁-11ₙ to correct for such external defect. An example of one implementation of LEDs with an image capture device for correcting for such an external defect is shown in FIG. 5, described further below.

FIG. 5 shows an example block diagram illustrating a portion of a digital camera 500. As with camera 100 of FIG. 1, camera 500 includes a lens 104 and a sensor 105 for capturing image data. Various other components, such as those described in FIG. 1 above may also be included in camera 500, although not shown for simplicity. Camera 500 also includes a strobe 501 (which, for example, corresponds to strobe 101 of FIG. 1) that includes a plurality of LEDs 51₁-51ₙ (referred to collectively as LEDs 51). In this example, LEDs 51 are colored. For instance, certain ones of the LEDs are red (labeled “R” in FIG. 5), certain ones are green (labeled “G” in FIG. 5), and certain ones are blue (labeled “B” in FIG. 5). Of course, other color schemes and arrangements of LEDs may be used in alternative implementations. Such LEDs 51 may be used to implement a lighting strategy that corrects for an external defect, such as an undesired color contributed to a scene by its ambient lighting.

Strobe control 502 may control the intensity of light output by different colored LEDs 51 of strobe 501 to correct for (or offset) an undesired color contributed to a scene by its ambient lighting. For instance, if a scene's ambient lighting contributes an undesired reddish color to the scene (e.g., as with tungsten light sources), the intensity of the colored LEDs 51 may be adjusted to implement a lighting strategy to correct such undesired reddish color of the scene. For instance, less power may be applied to the red LEDs of strobe 501, while more power may be applied to the blue and green LEDs of strobe 501 during the image capture process to offset the undesired red color contributed to the scene by its ambient lighting. As described above, the intensity of each LED may be controlled by controlling the amount of power supplied thereto and/or the arrangement of the LEDs. Thus, for example, strobe control 502 may selectively supply greater power to certain colored LEDs than others of the colored LEDs to implement a desired lighting strategy for correcting a defect.

As mentioned above with FIG. 1, in certain implementations strobe control 102 may use information available in a strobe profile 103 that is stored to a data storage unit (e.g., random access memory, flash memory, etc.) of camera 100 to determine the appropriate lighting strategy to be used for imaging a scene, and strobe control 102 may control the LEDs of strobe 101 (e.g., their arrangement and/or intensity) to implement such lighting strategy. FIG. 6 shows an example system 600 in which a camera which includes components as described above in FIG. 1 may be used for capturing an image of a scene 601. For instance, the example camera shown includes strobe 501 and strobe control 502 of FIG. 5.

Further, the example camera includes strobe profile information 103, which in this example includes external defect correction information 13_{B}. External defect correction information 13_{B} may include information regarding the type and amount of correction needed for an external defect of an image capture process, such as for correcting for undesired color of ambient lighting of scene 601. For instance, scene 601 is illuminated by an ambient light source 602 in this example, which supplies light 603 to scene 601. Such ambient light source 602 may include an undesired color in its supplied light 603. For example, if ambient light source 602 is a tungsten light source, it may contribute an undesired red color to scene 601. External defect correction information 13_{B} may include information regarding the amount and type of correction to be applied for each of various types of ambient light sources, such as tungsten lighting, sunlight, fluorescent lighting, etc. Thus, strobe control 502 may access external defect correction information 13_{B} and use that information to determine a proper lighting strategy to implement with strobe 501 for correcting an external defect of an image capture process (e.g., to offset undesired color contributed by a scene's ambient lighting).

Thus, for instance, in certain implementations a user may specify, via user controls 108, a type of ambient light source 602 under which scene 601 is being photographed (e.g., sunlight, fluorescent lighting, tungsten lighting, etc.), and logic 106 may convey this information to strobe control 502, which may determine (e.g., based on information available in strobe profile 103) the appropriate lighting strategy to be applied by strobe 501 during the image capture process. Alternatively, in certain implementations, scene lighting detector logic (or “illuminant detect logic”) 604 may be included in the camera for determining the ambient lighting conditions of scene 601. For instance, logic 604 may analyze the ambient lighting conditions of scene 601 and determine the type of ambient lighting 602 being used for illuminating scene 601. In which case, upon scene lighting detector logic 604 determining the type of ambient lighting 602, logic 106 may convey this information to strobe control 502, which may determine (e.g., based on information available in strobe profile 103) the appropriate lighting strategy to be applied by strobe 601 during the image capture process.

While FIGS. 3-4 are described above as implementing lighting strategies for correcting internal defects, it should be understood that those example lighting strategies may be used for correcting external defects of an image capture process (e.g., correct for undesired color contributed by a scene's ambient lighting) instead of or in addition to correcting for internal defects. Similarly, while FIGS. 5-6 are described above as implementing lighting strategies for correcting external defects of an image capture process, it should be understood that those example lighting strategies may be used for correcting internal defects of the image capture process instead of or in addition to correcting for external defects. Further, while the above techniques are described for correcting either internal or external defects, it should be understood that certain lighting strategies may be employed by the LEDs for simultaneously correcting both internal and external defects in accordance with an embodiment of the present invention.

Also, while the example strobes of FIGS. 1, 2, 3, and 6 show a single row (or line) of LEDs, embodiments of the present invention are not limited to such an arrangement. Rather, any other desirable arrangement may be employed. For example, the LEDs may be arranged as a two-dimensional array having a plurality of rows and columns of LEDs. Further, the LEDs need not all be arranged in a common area of the image capture device. That is, the LEDs need not necessarily be arranged as a contiguous array. For instance, in certain embodiments a portion of the LEDs may be arranged in one area of the image capture device and another portion of the LEDs may be arranged in another area thereof. As an example, a portion of the LEDs may be arranged on one side of a lens (e.g., lens 104 of FIG. 1) and another portion of the LEDs may be arranged on an opposite side of the lens. As another example, LEDs may be distributed around the lens to aid in achieving substantially even illumination, while also employing a lighting strategy for correcting one or more defects in the manner described above. Any such arrangement that enhances defect correction and/or improves scene illumination may be employed. Further, while an LED strobe according to embodiments of the present invention may be implemented within an image capture device, in certain embodiments such LED strobe may be implemented external to the image capture device. For instance, an LED strobe 101 and, in some implementations, the strobe control 102 may be implemented as an accessory that may be coupled to a camera as needed, such as with traditional “hot shoes.”

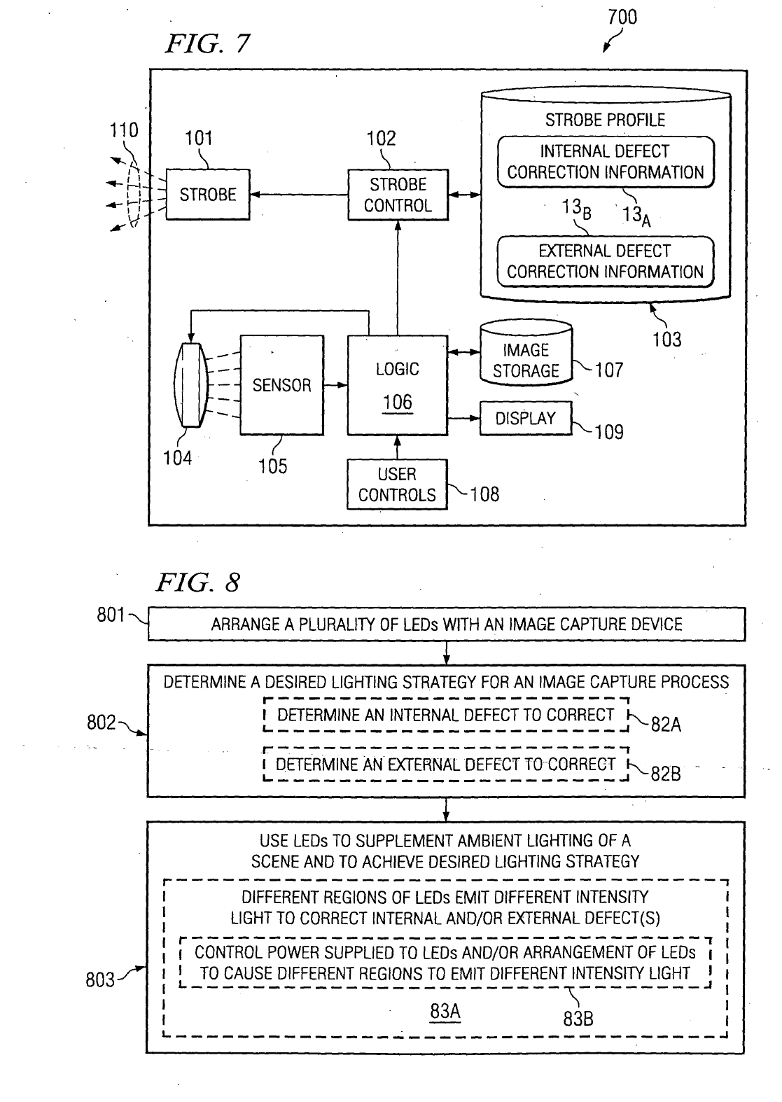

FIG. 7 shows an example camera 700 that includes strobe profile information 103 that includes both internal defect correction information 13_{A} and external defect correction information 13_{B}, which may be used for determining a proper lighting strategy to implement with LEDs for correcting the internal and external defects of an image capture process. Thus, in this example embodiment, a lighting strategy may be determined (e.g., by strobe control 102) to correct both internal and external defects of an image capture process, and strobe control 102 may control strobe 101 to achieve such lighting strategy.

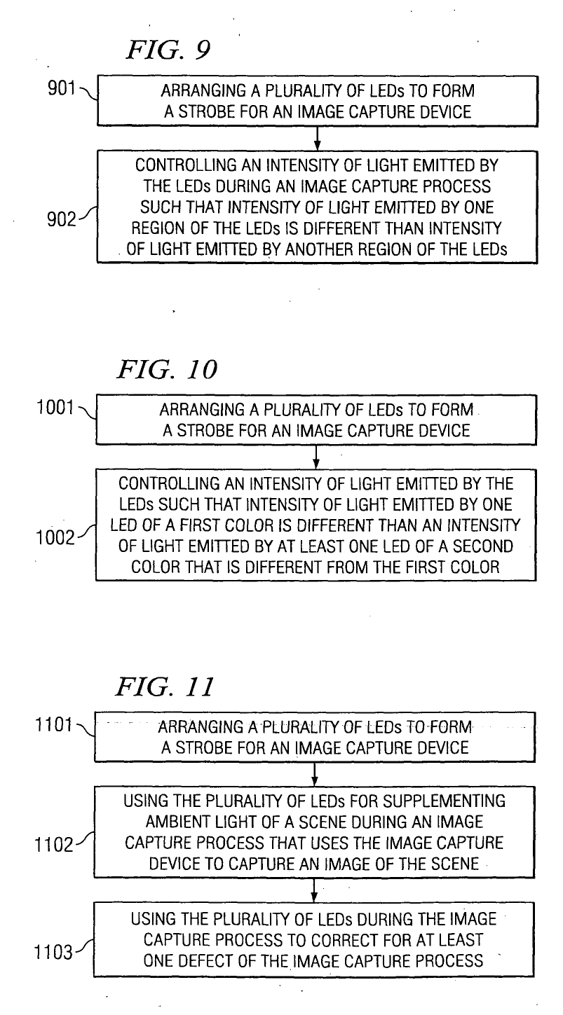

FIG. 8 shows an example operational flow diagram of an embodiment of the present invention. In operational block 801, a plurality of LEDs are arranged with an image capture device. In operational block 802, a desired lighting strategy is determined for an image capture process. Such determination may be made, for example, by strobe control logic 102, which may base such determination at least in part on information included in a strobe profile 103, as described above. In certain embodiments, the determination of a desired lighting strategy for an image capture process may include determining an internal defect to correct for the image capture process (block μ_{A} of FIG. 8) and/or determining an external defect to correct for the image capture process (block 82_{B} of FIG. 8).

In operational block 803, the LEDs of the image capture device are used to supplement ambient lighting of a scene and to achieve the desired lighting strategy. For instance, as described above, embodiments of the present invention utilize LEDs to not only supplement ambient lighting of a scene being imaged (as with traditional camera strobes), but utilizes the LEDs to supplement the ambient lighting in a way that corrects a defect (e.g., internal and/or external) of an image capture process. As used herein, it should be understood that an image capture process may vary for each image capture operation. For instance, a first external defect may exist for an image capture process for imaging a first scene, and a second external defect may exist for an image capture process for imaging a second scene (e.g., due to different ambient lighting of the first and second scenes, etc.). As shown in operational block 803, using the LEDs to achieve a desired lighting strategy (e.g., for correcting a defect of an image capture process) may involve different regions of the LEDs emitting different intensity light (operational block 82_{A}). Further, as shown in operational block 83B, the power supplied to each LED and/or the arrangement of the LEDs may be controlled (e.g., by strobe control logic 102) to cause the different regions to emit different intensity light.

FIG. 9 shows another example operational flow diagram of an embodiment of the present invention. In this example, operational block 901 comprises arranging a plurality of LEDs to form a strobe for an image capture device, and operational block 902 comprises controlling an intensity of light emitted by the LEDs during an image capture process such that intensity of light emitted by one region of the LEDs is different than intensity of light emitted by another region of the LEDs.

FIG. 10 shows yet another example operational flow diagram of an embodiment of the present invention. In this example, operational block 1001 comprises arranging a plurality of LEDs of different colors to form a strobe for an image capture device, and operational block 1002 comprises controlling an intensity of light emitted by the LEDs such that an intensity of light emitted by at least one LED of a first color is different than an intensity of light emitted by at least one LED of a second color that is different from the first color.

FIG. 11 shows still another example operational flow diagram of an embodiment of the present invention. In this example, operational block 1101 comprises arranging a plurality of LEDs to fonm a strobe for an image capture device, and operational block 1102 comprises using the plurality of LEDs for supplementing ambient light of a scene during an image capture process that uses the image capture device to capture an image of the scene. Further, operational block 1103 comprises using the plurality of LEDs during the image capture process to correct for at least one defect of the image capture process. In certain implementations, operational blocks 1102 and 1103 may be performed concurrently.

In view of the above, embodiments of the present invention utilize LEDs within an image capture device, such as a digital camera, film camera, video recorder, etc., to implement a lighting strategy that corrects for internal and/or external defects of an image capture process. As described above, embodiments of the present invention utilize LEDs to not only supplement ambient lighting of a scene being imaged, but utilizes the LEDs to supplement the ambient lighting of a scene in a way that corrects a defect (e.g., internal and/or external) of an image capture process.

1. A method comprising:
arranging a plurality of light emitting diodes (LEDs) to form a strobe for an image capture device; and
controlling an intensity of light emitted by said LEDs during an image capture process such that intensity of light emitted by one region of said LEDs is different than intensity of light emitted by another region of said LEDs.

2. The method of claim 1 wherein said controlling said intensity of light emitted by said LEDs during an image capture process comprises:
controlling an arrangement of said LEDs.

3. The method of claim 2 wherein said controlling arrangement of said LEDs comprises:
arranging said LEDs such that said one region is more densely populated with LEDs than said another region.

4. The method of claim 2 wherein said LEDs are arranged in said image capture device and said controlling an arrangement of said LEDs is performed during manufacturing of said image capture device.

5. The method of claim 2 wherein said LEDs are movable in said image capture device, and wherein said controlling an arrangement of said LEDs is performed after manufacturing of said image capture device.

6. The method of claim 5 further comprising:
including at least one actuator within said image capture device for moving at least one of said LEDs.

7. The method of claim 1 wherein said controlling said intensity of light emitted by said LEDs during an image capture process comprises:
controlling an amount of power supplied to each of said LEDs.

8. The method of claim 7 wherein more power is supplied to said LEDs of said one region than to said LEDs of said another region.

9. The method of claim 1 wherein said LEDs include LEDs of different colors, and wherein controlling said intensity of light emitted by said LEDs during an image capture process comprises:
controlling said intensity of light emitted by said LEDs such that an intensity of light emitted by at least one LED of a first color is different than an intensity of light emitted by at least one LED of a second color that is different than said first color.

10. The method of claim 1 further comprising:
determining an internal defect of an image capture process; and
controlling said intensity of light to correct said internal defect.

11. The method of claim 10 wherein said internal defect comprises an undesired feature contributed to an image by a lens of said image capture device.

12. The method of claim 1 further comprising:
determining an external defect of an image capture process; and
controlling said intensity of light to correct said external defect.

13. The method of claim 12 wherein said external defect comprises an undesired feature contributed to an image by ambient lighting of a scene being imaged by said image capture device.

14. The method of claim 13 wherein said undesired feature comprises an undesired color contributed to said scene by said ambient lighting.

15. The method of claim 14 wherein said LEDs include LEDs of different colors, and wherein said controlling said intensity of light to compensate for said external defect comprises:
controlling said intensity of light emitted by said LEDs such that an intensity of light emitted by at least one LED of a first color is different than an intensity of light emitted by at least one LED of a second color that is different from said first color.

16. A method comprising:
arranging a plurality of light emitting diodes (LEDs) of different colors to form a strobe for an image capture device; and
controlling an intensity of light emitted by said LEDs such that an intensity of light emitted by at least one LED of a first color is different than an intensity of light emitted by at least one LED of a second color that is different from said first color.

17. The method of claim 16 further comprising:
determining an external defect of an image capture process; and
controlling said intensity of light to correct said external defect.

18. The method of claim 17 wherein said external defect comprises an undesired feature contributed to an image by ambient lighting of a scene being imaged by said image capture device.

19. The method of claim 18 wherein said undesired feature comprises an undesired color contributed to said scene by said ambient lighting.

20. A method comprising:
arranging a plurality of light emitting diodes (LEDs) to form a strobe for an image capture device;
using said plurality of LEDs for supplementing ambient light of a scene during an image capture process that uses said image capture device to capture an image of said scene; and
using said plurality of LEDs during said image capture process to correct for at least one defect of said image capture process.

21. The method of claim 20 wherein said at least one defect includes an internal defect caused by said image capture device.

22. The method of claim 21 wherein said internal defect comprises an undesired feature contributed to an image by a lens of said image capture device.

23. The method of claim 20 wherein said at least one defect includes an external defect caused by a feature external to said image capture device.

24. The method of claim 23 wherein said external defect comprises an undesired color quality contributed to said scene being imaged by said image capture device by an ambient light source of said scene.

25. The method of claim 20 further comprising:
determining, for said image capture process, said at least one defect.

26. The method of claim 25 further comprising:
determining a lighting strategy for correcting the determined at least one defect.

27. The method of claim 26 further comprising:
using said LEDs to achieve said lighting strategy.

28. The method of claim 26 wherein said plurality of LEDs are used to supplement said ambient light in a manner that achieves said lighting strategy for correcting the determined at least one defect.

29. The method of claim 20 wherein said plurality of LEDs are used to concurrently supplement said ambient light of said scene and correct for the determined at least one defect.

30. An image capture device comprising:
a plurality of light emitting diodes (LEDs) forming a strobe; and
control logic for controlling an intensity of light emitted by said LEDs during an image capture process such that intensity of light emitted by one region of said LEDs is different than intensity of light emitted by another region of said LEDs.

31. The image capture device of claim 30, wherein said LEDs are movable in said image capture device, and wherein said control logic controls an arrangement of said LEDs.

32. The image capture device of claim 30 further comprising:
at least one actuator within said image capture device for moving at least one of said LEDs under control of said control logic.

33. The image capture device of claim 30 wherein said control logic controls an amount of power supplied to each of said LEDs.

34. The image capture device of claim 33 wherein said control logic is operable to cause more power to be supplied to said LEDs of said one region than to said LEDs of said another region.

35. The image capture device of claim 30 wherein said LEDs include LEDs of different colors.

36. The image capture device of claim 35 wherein control logic for controlling said intensity of light emitted by said LEDs during an image capture process controls said intensity of light emitted by said LEDs such that an intensity of light emitted by at least one LED of a first color is different than an intensity of light emitted by at least one LED of a second color that is different than said first color.

37. The image capture device of claim 30 further comprising:
logic for determining an internal defect of said image capture process, wherein said control logic controls said intensity of light to correct said internal defect.

38. The image capture device of claim 37 further comprising:
a lens, wherein said internal defect comprises an undesired feature contributed to an image by said lens.

39. The image capture device of claim 30 further comprising:
logic for determining an external defect of said image capture process, wherein said control logic controls said intensity of light to correct said external defect.

40. The image capture device of claim 39 wherein said external defect comprises an undesired feature contributed to an image by ambient lighting of a scene being imaged by said image capture device.

41. The image capture device of claim 40 wherein said undesired feature comprises an undesired color contributed to said scene by said ambient lighting.

42. A system comprising:
means for capturing an image of a scene, the capturing means comprising
means for generating illumination for the scene during an image capture process, wherein the generating means comprises a plurality of light emitting diodes (LEDs) for supplementing ambient light of the scene in a manner that corrects for at least one defect of said image capture process.

43. The system of claim 42 wherein said at least one defect includes an internal defect caused by the capturing means.

44. The system of claim 43 wherein the capturing means comprises a lens, and wherein said internal defect comprises an undesired feature contributed to an image by the lens of the capturing means.

45. The system of claim 42 wherein said at least one defect includes an external defect caused by a feature external to the capturing means.

46. The system of claim 45 wherein said external defect comprises an undesired color quality contributed to said scene by an ambient light source of said scene.

47. The system of claim 42 wherein the capturing means further comprises:
means for controlling an intensity of light emitted by said LEDs during said image capture process such that intensity of light emitted by one region of said LEDs is different than intensity of light emitted by another region of said LEDs.

48. The system of claim 42 wherein the capturing means further comprises:
means for controlling an intensity of light emitted by said LEDs during an image capture process such that an intensity of light emitted by at least one LED of a first color is different than an intensity of light emitted by at least one LED of a second color that is different than said first color.

49. An image capture device comprising:
a plurality of means for generating light for illuminating a scene being imaged by the image capture device during an image capture process; and
means for controlling an intensity of light emitted by the plurality of light generating means during the image capture process such that intensity of light emitted by at least one of the plurality of light generating means is different than intensity of light emitted by at least one other of the plurality of light generating means.

50. An image capture device comprising:
a plurality of means for generating light for illuminating a scene being imaged by the image capture device during an image capture process, wherein the plurality of light generating means comprise at least one means for generating light of a first color and at least one means for generating light of a second color that is different from said first color; and
means for controlling an intensity of light emitted by the plurality of light generating means during the image capture process such that an intensity of light emitted by said at least one means for generating light of said first color is different than an intensity of light emitted by said at least one means for generating light of said second color.
